(19) United States
(12) Patent Application Publication
(10) Pub. No.: US 2026/0311011 A1
(43) Pub. Date: Oct. 8, 2026

(54) CANARY QUBITS

(71) Applicant: Dell Products L.P., Round Rock, TX (US)

(72) Inventors: Brendan Burns Healy, Haddonfield, NJ (US); Robert Lee, Marlborough, MA (US)

(21) Appl. No.: 19/098,237

(22) Filed: Apr. 2, 2025

(51) Int. Cl. G06N 10/20

(52) U.S. Cl. CPC G06N 10/20

(57) ABSTRACT

One example method includes receiving a quantum circuit for execution on a QPU (quantum processing unit), assigning qubits of the QPU to logical qubits of the quantum circuit, automatically adding, to the quantum circuit, one or more remaining qubits of the QPU as canary qubits, transmitting the quantum circuit to the QPU for execution, and transmitting one or more gate sequences to the QPU for execution by the canary qubits, and execution of the quantum circuit and execution of the gate sequences collectively comprise a single shot.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to quantum computing components and processes. More particularly, at least some embodiments relate to systems, hardware, software, computer-readable media, and methods, for error detection in a quantum computing environment.

### BACKGROUND

One drawback of QPUs (quantum processing units) as an accelerator, rather than a commodity, is that there is usually not a rightsized processor available for a given job, that is, a processor whose capabilities and capacity closely match the requirements of the job. Thus, a user is typically forced to choose among a limited set of QPUs that have certain capacities, which usually are not dynamically split for multiple workloads. This often leads to underutilization of the QPU.

As well, QPUs are prone to significant amounts of noise. Certain processors, and certain algorithms, are likely to produce results that are so confounded by error and noise that there is no signal left and, thus, no solution to the intended problem.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses an example of two gate sequences that are mathematically equivalent to the identity operator.

FIG. 2 discloses aspects of an example architecture, according to one embodiment.

FIG. 3 discloses aspects of an example method according to one embodiment.

FIG. 4 discloses a computing entity configured and operable to perform any of the disclosed methods, processes, and operations. The computing entity may comprise quantum computing components and/or classical computing components.

### DETAILED DESCRIPTION OF SOME EXAMPLE EMBODIMENTS

Embodiments disclosed herein generally relate to quantum computing components and processes. More particularly, at least some embodiments relate to systems, hardware, software, computer-readable media, and methods, for error detection in a quantum computing environment.

Example embodiments comprise an architecture and method for improving QPU utilization while also reducing error in the QPU output. In an embodiment, this functionality may be implemented by a middleware layer. In one embodiment, the middleware layer may comprise a quantum management + orchestration engine such as, for example, the Dell DQCS or QIO. In particular, reference is made below to a DQCS (Dell Quantum Computing Solution).

For example, see, e.g., https://thequantuminsider.com/2022/11/15/dell-technologies-advances-high-performance-computing-with-hybrid-quantum-classical-system/. The DQCS comprises a specific server configuration that may be employed, in one embodiment, to provide a platform for launching hybrid quantum-classical jobs. The DQCS may comprise an implementation of a classical computing node positioned between a quantum accelerator and an end-user. In an embodiment, the middleware layer may comprise a Dell QIO (Quantum Intelligent Orchestrator). A QIO is one particular implementation of a classical computing middleware layer handling orchestration tasks.

A method according to one embodiment may be performed in connection with a transpilation process in which physical qubits of a QPU are assigned to logical qubits of a circuit that has been submitted for execution. This example method may comprise various operations including but not limited to: allocating one or more unused qubits as ‘canary’ qubits; applying a sequence of gates to the canary qubits; measuring respective values of the canary qubits after the sequence of gates has been applied; determining that one of the canary qubits evaluates to 1; and, discarding the shot, or shots, that resulted in the canary qubit evaluating to 1. Note that as used here, a ‘shot’ refers a single execution of a quantum circuit.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that QPU utilization may be improved, relative at least to conventional approaches. An embodiment may reduce the noise generated in execution of a quantum circuit. Various other advantages of one or more example embodiments will be apparent from this disclosure.

### A. Context for One or More Embodiments

The following is a discussion of aspects of example context for various embodiments. This discussion is not intended to limit the scope of the claims or this disclosure, or the applicability of the embodiments, in any way.

As noted above, it commonly occurs that execution of a quantum circuit on a QPU does not require the use of all the physical qubits of the QPU. That is, there are extra physical qubits of the QPU that are not utilized in that execution.

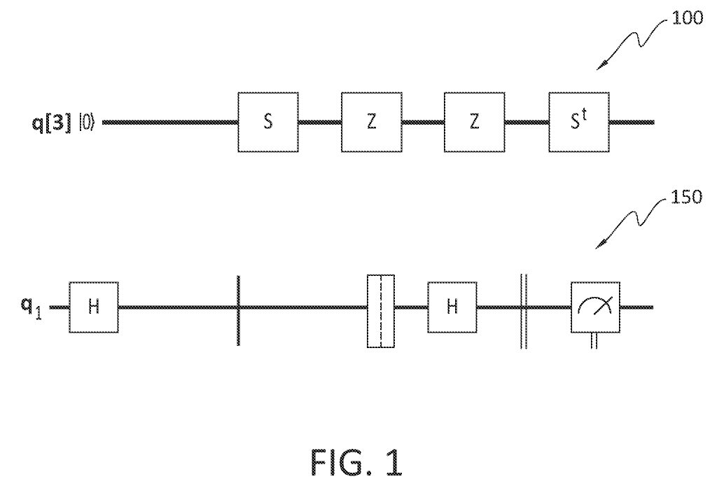

With reference now to the example of FIG. 1, one way that QPUs are benchmarked is by executing a sequence of gates, such as the sequences 100 and 150, on an individual qubit, or possible multiple qubits. Mathematically, this execution should result in nothing being done. That is, if the qubit was initialized in the |0> state, it should be measured as a zero. If a measurement ever results in 1, this is noted as error due to noise. As disclosed herein, some example embodiments comprise an approach for dealing with these differing results.

### B. DETAILED DISCUSSION

### B.1 Example Embodiment of an Architecture

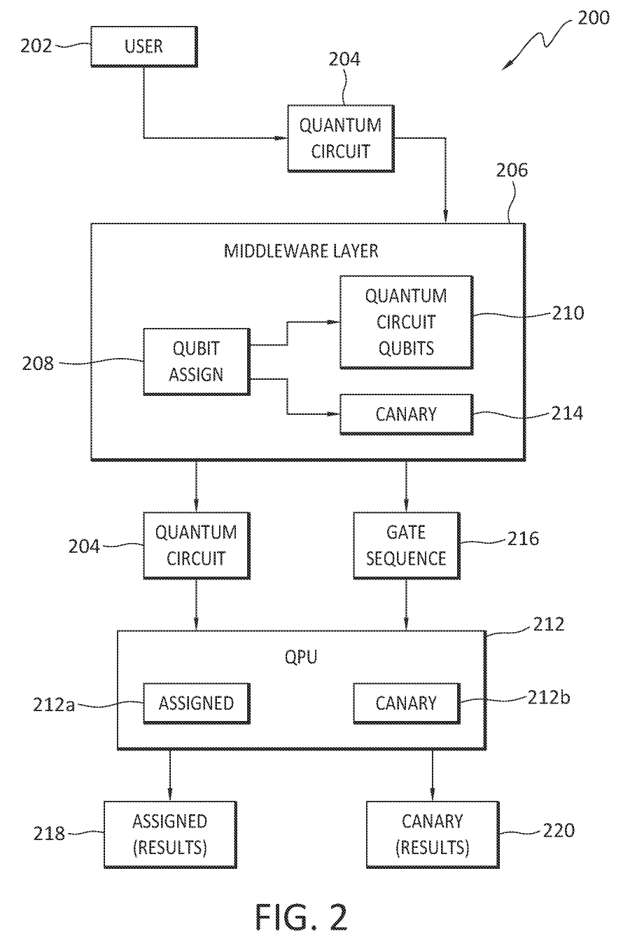

With attention now to FIG. 2, details are provided concerning an architecture 200 according to one embodiment. As shown there, a user 202 may submit a quantum circuit 204 for execution. The quantum circuit 204 may be submitted to a middleware layer 206, which may be implemented with classical computing hardware and/or software, that may perform various functions including, for example, transpilation and orchestration.

As to transpilation, the middleware layer 206 may implement a qubit assignment function 208 in which qubits 210 of a QPU 212 are assigned to the quantum circuit 204. Typically, not all of the qubits are assigned and, in an embodiment, one, some, or all, of the unassigned qubits may be assigned as canary qubits 214.

After transpilation, the quantum circuit 204 and one or more gate sequences 216, which may be user-assigned and user-provided, may be passed to the QPU 212 for execution. As a result of the transpilation, the QPU 212 may thus comprise an assigned group 212a of qubits, that is, assigned to the quantum circuit 204, as well as a group of canary qubits 212b not assigned to the quantum circuit 204.

The qubits 212a may then be used to execute the quantum circuit 204, while the canary qubits 212b may be used to execute the gate sequences 216. Each of these different executions may generate respective results 218 and 220. As discussed below, these results may be used to improve the results obtained when executing one or more shots of the quantum circuit 204 on the QPU 212.

### B.2 Overview of Aspects of an Example Embodiment of a Method

As noted above, one example embodiment may comprise a middleware that automatically adjusts submitted circuits in such a way to both (i) improve qubit utilization and (ii) detect error, at once. In particular, during a transpilation operation that comprises the assignment of physical qubits to logical qubits, this middleware may assign extra, unused physical qubits to act as the “canary in the coal mine.” That is, unused qubits, which may comprise, one, all, or only some, qubits, will have a sequence of gates applied to them that should theoretically, at least, result in a zero state.

Then, on measurement, an embodiment may check the value of the canary qubits. In the event one or more of the canary qubits evaluates to 1, it may be deduced that some form of decoherence or noise has likely affected the QPU. The middleware layer may then, in an automatic process not visible to the user, throw out these shots from the results. This will result in a higher fidelity of results, lowering the noise and making the signal more apparent. Thus one advantageous aspect of an embodiment is the addition of an error-detecting sequence of gates automatically to submitted quantum circuits in order to detect environmental error.

### B.3 Discussion of an Example Embodiment of a Method

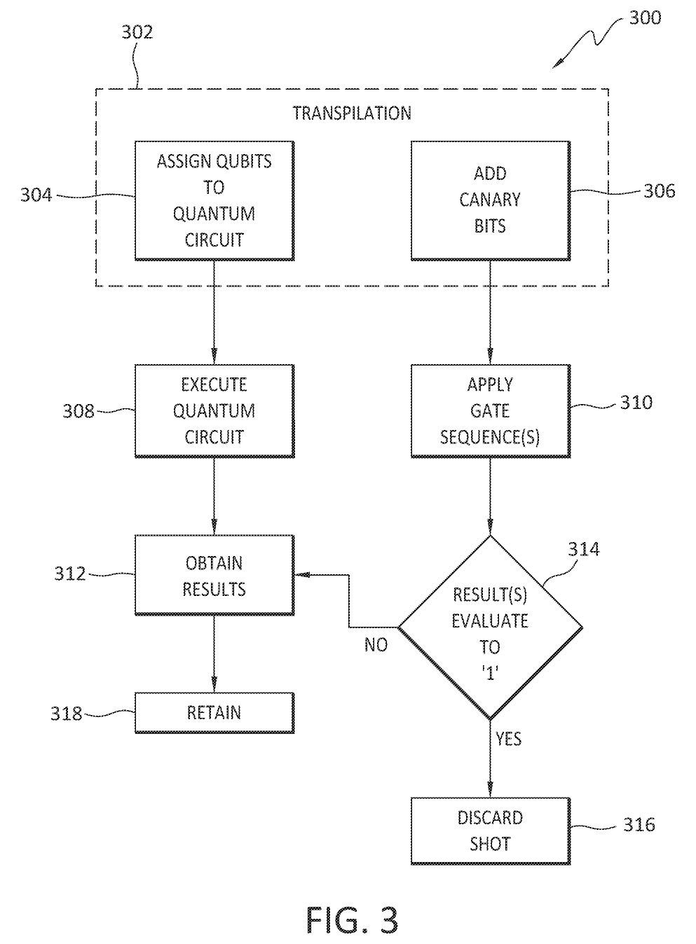

With reference now to FIG. 3, details are provided concerning an example method 300 according to one embodiment. In one embodiment, a portion of the method 300 is performed as part of a transpilation process 302, but that is not necessarily required in all cases.

Initially, qubits of a QPU may be assigned 304 to a quantum circuit that was received for execution. Each execution of a quantum circuit may be referred to as a ‘shot.’ Because the outcome of the execution of a quantum circuit is probabilistic, rather than deterministic, multiple shots may be employed to obtain a solution. One or more unused qubits of the QPU may be added to the quantum circuit 306 as ‘canary’ bits. In one embodiment, 304 may be performed prior to 306 to enable a determination as to how many qubits are needed. For second, and subsequent, shots, the number of needed qubits to execute the quantum circuit may already be known from the initial shot, such that 304 and 306 can be performed simultaneously, or 306 may be performed prior to 304.

Next, the quantum circuit may be executed 308 on the assigned qubits of the QPU. As part of the same shot that includes 308, one or more gate sequences may be applied 310 to the assigned canary qubits. The results of the executions may then be obtained 312 and analyzed 314. If the analysis 314 reveals that the results of application of the gate sequences to the canary bit(s) evaluates to ‘1,’ then the shot results are discarded 316 as being unacceptably noisy. On the other hand, if the analysis 314 reveals that the results of application of the gate sequences to the canary bit(s) evaluates to ‘1,’ then the shot results are retained 318, such as for consideration along with the results of one or more additional shots.

### C. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### D. Further Example Embodiments

Following are some further example embodiments. These are presented only by way of example and are not intended to limit the scope of this disclosure or the claims in any way.

Embodiment 1. A method, comprising: receiving a quantum circuit for execution on a QPU (quantum processing unit); assigning qubits of the QPU to logical qubits of the quantum circuit; automatically adding, to the quantum circuit, one or more remaining qubits of the QPU as canary qubits; transmitting the quantum circuit to the QPU for execution; and transmitting one or more gate sequences to the QPU for execution by the canary qubits, and execution of the quantum circuit and execution of the gate sequences collectively comprise a single shot.

Embodiment 2. The method as recited in claim 1, wherein when one of the canary qubits evaluates to ‘1,’ discarding the shot as erroneous due to noise.

Embodiment 3. The method as recited in claim 1, wherein when none of the canary qubits evaluates to ‘1,’ the shot is retained.

Embodiment 4. The method as recited in claim 1, wherein the assigning of the qubits to the QPU, and the assignment of the canary qubits, are performed as part of a transpilation process.

Embodiment 5. The method as recited in claim 1, wherein one, some, or all, of the qubits remaining after assignment of the qubits to the QPU, are assigned as the canary qubits.

Embodiment 6. The method as recited in claim 1, wherein one of the canary qubits evaluating to ‘1’ is indicative of decoherence or noise affecting the QPU.

Embodiment 7. The method as recited in claim 1, wherein the one or more gate sequences are automatically added to the quantum circuit prior to execution.

Embodiment 8. The method as recited in claim 1, wherein each of the qubits of the QPU is used either to support execution of one of the canary qubits or to support execution of the quantum circuit.

Embodiment 9. The method as recited in claim 1, wherein automatically adding the canary qubits is performed by a middleware layer.

Embodiment 10. The method as recited in claim 1, wherein the execution of the canary qubits and the logical qubits are performed at the same time.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

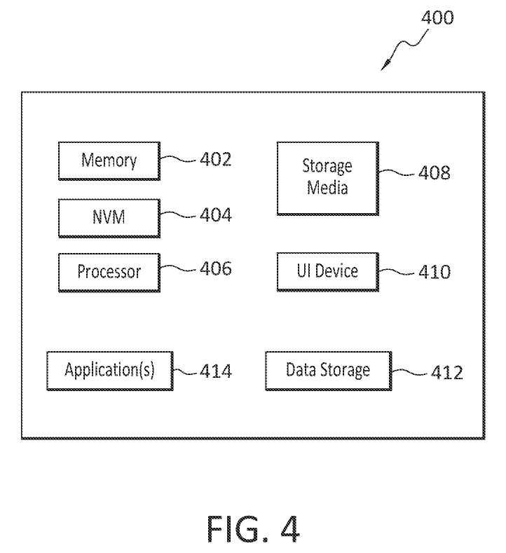

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid-state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving a quantum circuit for execution on a QPU (quantum processing unit);
assigning qubits of the QPU to logical qubits of the quantum circuit;
automatically adding, to the quantum circuit, one or more remaining qubits of the QPU as canary qubits;
transmitting the quantum circuit to the QPU for execution; and
transmitting one or more gate sequences to the QPU for execution by the canary qubits, and execution of the quantum circuit and execution of the gate sequences collectively comprise a single shot.

2. The method as recited in claim 1, wherein when one of the canary qubits evaluates to ‘1,’ discarding the shot as erroneous due to noise.

3. The method as recited in claim 1, wherein when none of the canary qubits evaluates to ‘1,’ the shot is retained.

4. The method as recited in claim 1, wherein the assigning of the qubits to the QPU, and the assignment of the canary qubits, are performed as part of a transpilation process.

5. The method as recited in claim 1, wherein one, some, or all, of the qubits remaining after assignment of the qubits to the QPU, are assigned as the canary qubits.

6. The method as recited in claim 1, wherein one of the canary qubits evaluating to ‘1’ is indicative of decoherence or noise affecting the QPU.

7. The method as recited in claim 1, wherein the one or more gate sequences are automatically added to the quantum circuit prior to execution.

8. The method as recited in claim 1, wherein each of the qubits of the QPU is used either to support execution of one of the canary qubits or to support execution of the quantum circuit.

9. The method as recited in claim 1, wherein automatically adding the canary qubits is performed by a middleware layer.

10. The method as recited in claim 1, wherein the execution of the canary qubits and the logical qubits are performed at the same time.

11. A non-transitory storage medium having stored therein instructions that are executable by one or more hardware processors to perform operations comprising:
receiving a quantum circuit for execution on a QPU (quantum processing unit);
assigning qubits of the QPU to logical qubits of the quantum circuit;
automatically adding, to the quantum circuit, one or more remaining qubits of the QPU as canary qubits;
transmitting the quantum circuit to the QPU for execution; and
transmitting one or more gate sequences to the QPU for execution by the canary qubits, and execution of the quantum circuit and execution of the gate sequences collectively comprise a single shot.

12. The non-transitory storage medium as recited in claim 11, wherein when one of the canary qubits evaluates to ‘1,’ discarding the shot as erroneous due to noise.

13. The non-transitory storage medium as recited in claim 11, wherein when none of the canary qubits evaluates to ‘1,’ the shot is retained.

14. The non-transitory storage medium as recited in claim 11, wherein the assigning of the qubits to the QPU, and the assignment of the canary qubits, are performed as part of a transpilation process.

15. The non-transitory storage medium as recited in claim 11, wherein one, some, or all, of the qubits remaining after assignment of the qubits to the QPU, are assigned as the canary qubits.

16. The non-transitory storage medium as recited in claim 11, wherein one of the canary qubits evaluating to ‘1’ is indicative of decoherence or noise affecting the QPU.

17. The non-transitory storage medium as recited in claim 11, wherein the one or more gate sequences are automatically added to the quantum circuit prior to execution.

18. The non-transitory storage medium as recited in claim 11, wherein each of the qubits of the QPU is used either to support execution of one of the canary qubits or to support execution of the quantum circuit.

19. The non-transitory storage medium as recited in claim 11, wherein automatically adding the canary qubits is performed by a middleware layer.

20. The non-transitory storage medium as recited in claim 11, wherein the execution of the canary qubits and the logical qubits are performed at the same time.
